(19) United States
(12) Patent Application Publication
(10) Pub. No.: US 2009/0248376 A1
(43) Pub. Date: Oct. 1, 2009

(54) Complex Network Mapping

(76) Inventors: Gabriel A. Silva, Del Mar, CA (US); Marius Buibas, Chula Vista, CA (US); Hargun S. Khanna, San Jose, CA (US)

Correspondence Address: FISH & RICHARDSON, PC, P.O. BOX 1022, MINNEAPOLIS, MN, 55440-1022, US

(21) Appl. No.: 12/514,296

(22) PCT Filed: Nov. 8, 2007
(86) PCT No.: PCT/US07/84182

§ 371 Date: May 8, 2009

Related U.S. Application Data
(60) Provisional application No. 60/864,957, filed on Nov. 8, 2006.

(51) Int. Cl. G06F 17/10; H04L 12/28; G06F 11/34

(52) U.S. Cl. 703/2; 709/224

(57) ABSTRACT

Techniques, system designs, computer program products for analyzing activities of networked systems and providing a functional mapping of a complex network.

### CROSS REFERENCE TO RELATED APPLICATIONS

This application claims priority under 35 U.S.C. §119(e)(1) from U.S. Provisional Patent Application No. 60/864,957, entitled “COMPLEX NETWORK MAPPING” and filed on Nov. 8, 2006. The provisional application is incorporated herein by reference in its entirety.

### STATEMENT AS TO FEDERALLY SPONSORED RESEARCH

The research and development for inventions described in this application received funding under NIH Grant No. R01 NS054736-01 from the National Institutes of Health. The U.S. Government may have rights to various technical features described in this application.

### BACKGROUND

This application relates to techniques for analyzing activities of networked systems, including signaling behaviors and information flow in networked systems.

A networked system includes nodes and links that connect the nodes. The activities of the nodes and the links can dynamically change. Hence, such a networked system can be complex in the sense that the properties and activities of the nodes can dynamically change in space and time. Examples of networked systems include but are not limited to, computer networks such as the Internet, integrated circuit networks, a power grid network, a biological network such as the neural network in the human brain or protein interaction networks in a cell, social networks, software objects in a computer database or web pages in a search engine, and artificial neural networks consisting of artificial neuronal elements.

### SUMMARY

Examples and implementations of techniques, system designs, computer program products are described to analyze activities of networked systems and provide a functional mapping of a complex network. In one aspect, a method for analyzing a networked system monitors activation and deactivation of nodes in the networked system to obtain information on activation times and deactivation times of nodes and locations of nodes, and uses activation times and deactivation times of nodes to generate a connection link between first and second nodes at two different node locations when the first node is activated at the same time as a signaling from the second node reaches the location of the first node, thus producing a connection map of nodes in the networked system.

In another aspect, the techniques for analyzing activities of networked systems described in this application include a method for analyzing a networked system which monitors activation and deactivation of nodes in a networked system to obtain information on activation times and deactivation times of nodes and locations of nodes, and applies a signaling model to generate a timing matrix of the nodes in the networked system to hold signaling times for a signal to travel from one node to a different node. This method further compares signaling times in the timing matrix and monitored activation times of the nodes to generate a map of connection links between different nodes.

In another aspect, a method for constructing a functional structure map of a networked system includes capturing activation states of a set of network vertices over a period of time; comparing a first vertex that is activated in a current time to one or more second vertices that are newly activated in a later time; and adding a connection between the first vertex and the one or more second vertices if a signaling volume expanding from first vertex can reach the one or more second vertices within a tolerance.

In another aspect, a system for analyzing a networked system includes an imaging module to process a set of sequential images of a networked system to determine locations of nodes and activation times of the nodes in the networked system; and a mapping module in communication with the imaging module to generate network connections based on the determined locations of the nodes and the determined activation times of the nodes in the networked system.

These and other aspects, implementations of described techniques and their variations are described in greater detail in the drawings, the detailed description and the claims.

### BRIEF DESCRIPTION OF DRAWINGS

FIG. 1A is a complex network with signaling volumes.

FIG. 1B shows functional connections between the nodes of FIG. 1A.

FIG. 2 illustrates one exemplary implementation of a system for analyzing a networked system and associated processes for a network mapping algorithm.

FIG. 3 depicts multiple modules for analyzing complex networks.

FIG. 4 is a flow diagram of a network mapping algorithm.

FIG. 5 is a detailed flow diagram of a network mapping algorithm.

### DETAILED DESCRIPTION

The characterization, classification, and analysis of complex networks using graph theoretical, statistical, and correlation methods provide descriptive and predictive insight into their behaviors. Various graph theoretical, statistical, and correlation methods tend not to readily provide an approach for determining or deriving the spatiotemporal evolving functional structure of a network, e.g., how the links between nodes that make up the network connect to each other in space and time. Given the very large number of potential links in a complex network, it may not be practical or possible to individually probe for the existence of all individual connections between nodes. Various statistical methods for analysis of networks require knowledge of a large number of connections to provide valid analysis and this knowledge can be difficult to obtain for a complex network. Many statistical methods are designed to derive only the probability of a connection between nodes of a network and are not capable of deriving the functional structure of the network.

The functional structure of a network can be defined as a product of the network's internal states (e.g., which nodes or vertices in the network were recently active and when they can be re-activated) and the history of how the network was stimulated (e.g., activating different starting nodes may produce different patterns of activated links). As such, the functional structure of a network at any given moment can be distinct from the static physical structural map of existing links. The information in the functional structure directly takes into account the dynamic temporal evolution of signaling events in the network as a function of the spatial relationship between nodes and therefore the spatial topology of the network, considerations that are usually not taken into account by graph theory and related approaches. The functional structure can be different from the concept of periodic and cyclic motifs that describe potential functional loops in networks but do not distinguish what links are active at any given moment. The functional structure can be represented by a connection map or connectivity map which includes data of the spatiotemporal evolution of the functional topology or structure of the nodes in the networked system.

The dynamic functional structure of a network as presented here can be deterministically mapped by taking into account the signaling speed with which signals propagate between nodes, the delay time between when a node receives a signal and when the node begins to propagate the signal on to other nodes, a refractory period during which a node cannot be re-activated, and the spatial organization of nodes relative to each other. The parameters used in the mapping can be measured or estimated by qualitatively observing signaling events in the network.

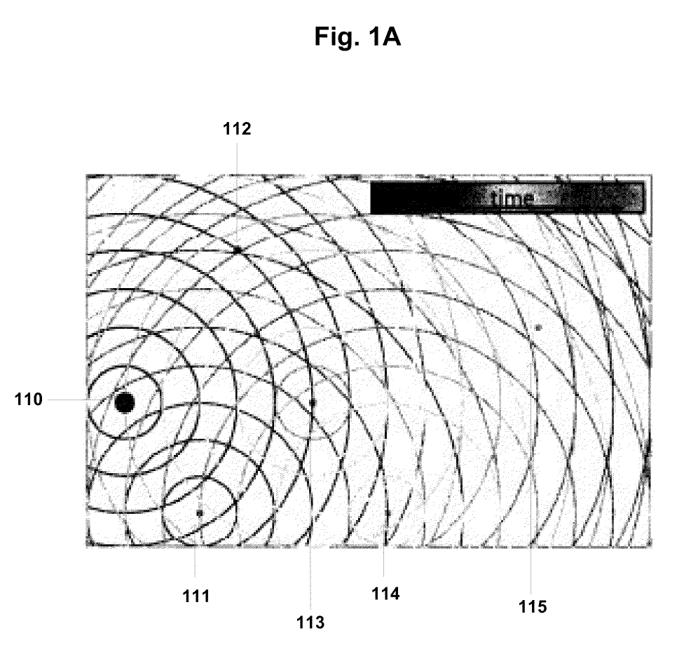

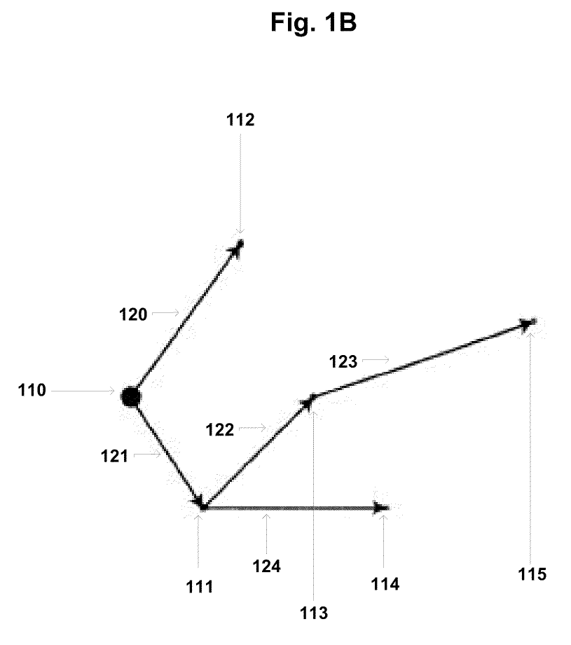

FIG. 1A depicts one exemplary configuration of a complex network of vertices or nodes and associated potential signal propagations between those vertices. The physical locations of the vertices can be in a two dimensional plane or in a three dimensional volume. Vertices 110-115 can be implemented in various configurations, including, but not limited to, interconnects, circuit nodes, neurons, digital processors such as Internet routers, content objects in a computer database, etc.

A signaling model can be used to determine the functional connections between vertices 110-115. The model can describe the time for a signal to propagate between a first vertex and a second vertex. When the functional connections are unknown, all potential paths for signal propagation have to be considered in order to determine the actual paths of the signal propagation. In the example in FIG. 1A, these potential paths are contained in the concentric circles centered on the vertices.

Signals can spread from vertices within the growing circles, referred to as signaling volumes (or signaling areas or signaling surfaces), in two dimensional networks and spheres in three dimensions with Δγ as the thickness of the perimeter of the expanding circle in two dimensions or shell in three dimensions. The vertices 110-115 are connected by edges whose physical dimensions represent the shortest Euclidian distance between the pair of vertices. The activation time of a particular vertex sets the initial time reference for the circles centered about the vertex. The growth rate, i.e., rate of change, of a signaling volume represents the signaling speed of the network. The growth rate can be a constant value, a scalar, or vector valued function. Vertex 110 is the first vertex to be activated in the network. Circles surrounding vertex 110 discretely indicate growing signaling volumes with larger radii indicating a signaling volume where greater time has elapsed. Signaling volumes grow continuously, but, for the sake of clarity, the signaling volumes are discretely shown as circles in FIG. 1A.

A functional connection between two vertices, also called an edge or a connection link, is established when a vertex goes from being inactive to active at the same moment (within a Δγ tolerance) a signaling volume reaches the vertex from a previously activated vertex. Hence, when a potential signal reaches a vertex and the vertex becomes activated, a functional connection is assumed to exist between the vertex that propagates the signal to the newly activated vertex.

FIG. 1B depicts an example of a deterministic mapping showing the functional connections 120-124 based on the network's dynamics of FIG. 1A. When a signaling volume centered around vertex 110 reaches vertex 111 and vertex 111 becomes activated, where vertex 111 has not previously been activated, an edge 121 is created between vertices 110 and 111 in the mapping. When the signaling volume expands further and vertex 112 becomes activated, edge 120 is created between vertices 110 and 112 in the mapping. When vertex 111 becomes activated, the vertex 111 starts a new signal propagation. When the signaling volume from vertex 111 reaches vertex 113 and vertex 113 becomes active, an edge 122 is created between vertices 111 and 113. This process continues for the remaining vertices of the figure.

A system for analyzing a networked system can be constructed to include an imaging module to process a set of sequential images of a networked system to determine locations of nodes and activation times of the nodes in the networked system. This system can include a mapping module in communication with the imaging module to generate network connections based on the determined locations of the nodes and the determined activation times of the nodes in the networked system. In one implementation of this system, a simulation module can be provided to be in communication with the mapping module to use the generated network connections to simulate the networked system to produce a set of sequential images of the simulated networked system and to compare the set of sequential images of the simulated networked system to the set of sequential images of the networked system. Such a system can be used in various applications to analyze complex networked systems and to construct artificial networked systems.

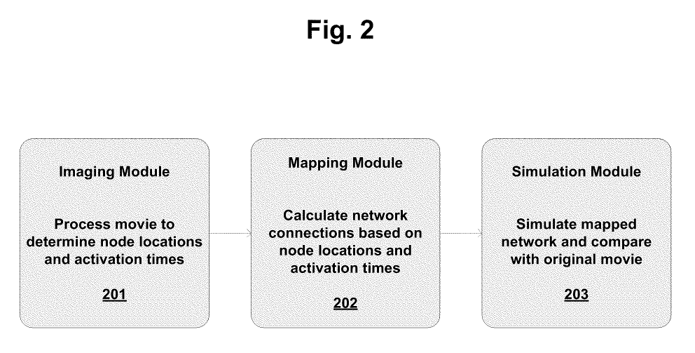

FIG. 2 illustrates one exemplary implementation of a system for analyzing a networked system and associated processes for a network mapping algorithm. This system can be implemented in a single computer or two or more networked computers. The imaging module 201 processes a movie to determine node locations and activation times. The movie captures network activity over a period of time. The period of time can be configured by the user. The movie can be a series in time of photographs of a complex network that capture node activity within the network. Individual photographs can be referred to as frames. In other embodiments, a frame can contain true/false indications of node activity for each node in the network at a particular time and a spatial description of each node; in other embodiments, the spatial description can be stored in a metadata file associated with the movie and not in every frame of the movie. The imaging module 201 can be configured to monitor the frames of a movie to generate an activation state matrix (indexed by node id and frame time stamp). The activation state matrix specifies the time and location of node activations. The mapping module 202 can take as input the node locations and the activation matrix determined by the imaging module 202. The mapping module 202 applies a mapping algorithm to derive the dynamic functional structure of the network. The structure contains the functional links (edges) between the nodes and can be referred to as the edge matrix or the connection map. In the simulation module 203, a user can simulate the mapped network and compare the mapped network with the original movie.

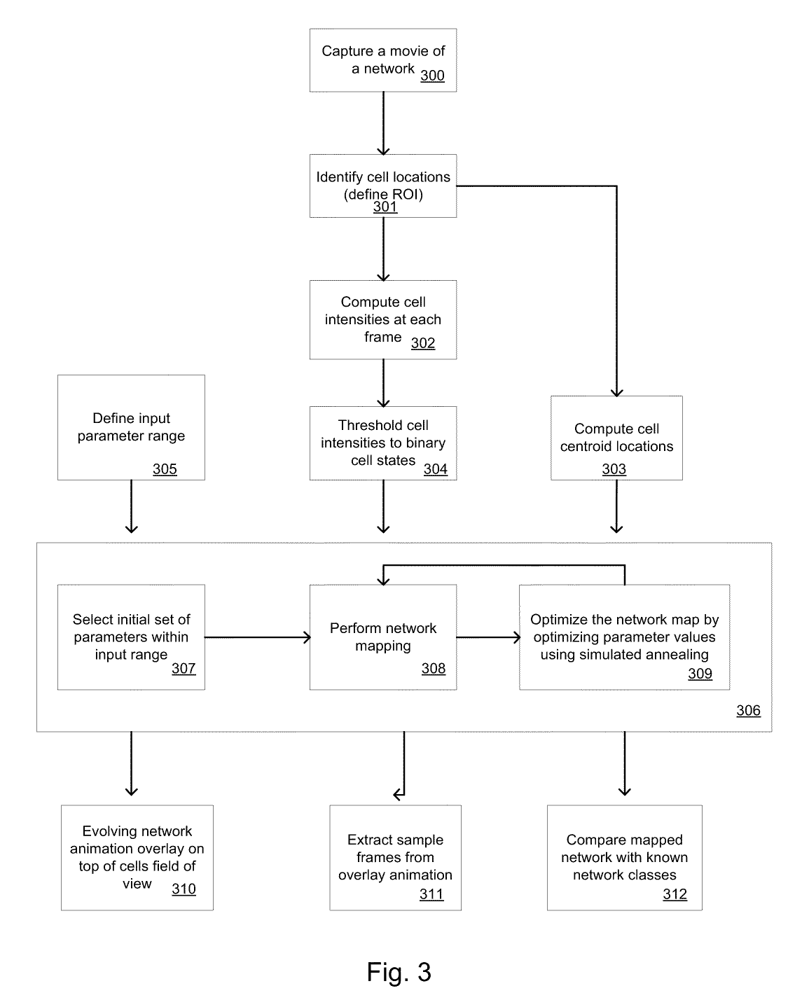

FIG. 3 depicts one implementation of a series of processes needed for an analyzing a complex network where the network contains biological neurons (cells). These biological neurons have been treated with a chemical to give off light when activated which can be captured by a movie. Step 300 captures a movie of a network such as a sequence of images of the network over time at different times or a time lapse series of photographs of the treated neurons or a continuous video stream of the network. In step 301, a user can identify a region of interest (ROI) within the movie. A user can configure the algorithm to process either a subset of the nodes shown in the movie or all of the nodes shown in the movie. A user can select a different ROI and rerun the analyze. Step 303 determines the cell centroid locations (spatial description) and further derives the set of node locations. From the spatial description of the nodes, a Cartesian distance between the nodes can be computed. Step 302 analyzes each frame and for each frame computes the cell intensities for all of the frame's cells. The intensity is a measure of light given of by a cell. Step 304 translates each of the cell's light intensity of step 302 into a binary indication of the cell's state: activated or not activated. A threshold value can be used to determine whether a cell's light intensity merits an activated indication. Step 304 then takes the cell state information for each frame and constructs the activation state matrix. Step 305 receives an input parameter range for each parameter of the mapping algorithm.

The mapping algorithm 306 can contain three steps 307-309. In step 307, a user selects an initial set of parameters within the input range. Step 308 executes the core mapping algorithm where the algorithm analyzes the activation state matrix based on the set of parameters to produce an edge matrix containing the functional links between the cells. In optional step 309, step 309 can be used to optimize the parameters selected in step 307 and step 308 can be rerun using the optimized parameters. Simulated annealing can be used to perform the optimizations.

Steps 310-312 cover post-processing of the edge matrix generated by the mapping algorithm. In step 310, a user can overlay the edge matrix over the cells of the movie to illustrate the propagation of signals through the network (an overlay animation). In step 311, a user can extract sample frames from the overlay animation for display. In step 312, a user can compare the mapped network with known network classes.

The following describes one example of the mapping algorithm. The algorithm can be configured to operate on a graph G comprising a set of network vertices V and a set of connections between those vertices. The algorithm will generate an edge matrix E. Vertex locations can be specified in either two or three dimensional points. Vᵢ refers to the spatial coordinates of vertex i. One of the inputs to the algorithm is the activation state matrix A generated by the imaging module 201. Matrix A contains the states of each vertex i at each discretely sampled time frame k, with elements aᵢₖ defined as follows:

$${a}_{ik} = \{ \begin{matrix}1 & if vertex i becomes active at time point k \\ 0 & otherwise\end{matrix}$$

Once a vertex becomes active, the vertex can propagate a signal to other vertices. A signaling model can describe how signals travel between vertices. The signaling model contains a signaling surface that is initially zero in surface area or volume. The signaling surface will propagate through space with a finite speed after the signaling event occurs. The signal can travel in any or all directions and can terminate at some distance from or time after activation. The signaling surface originating at vertex i can be defined as:

Sᵢ(Vᵢ, x, t)=ƒ(x, t)+Vᵢ, ƒ(x, 0)=0, t≧0

Here Sᵢ(Vᵢ, x, t) describes the surface in space where the signal from vertex Vᵢ can be at time t, given an activation event of the vertex at time t=0. f(x, t) is a non-negative, spatially (x) and temporally (t) variant signaling function which is 0 at time 0. Thus at time t=0, Sᵢ equals the starting point of the signal, Vi. The activation event of a vertex happens when the vertex is capable of being activated and the vertex receives a signal from one or more vertices. In one embodiment, vertex activation requires a signal from only one different vertex and activation is followed by a refractory period p in which no other activations of the vertex can occur.

In an alternative representation of Sᵢ, Sᵢ can be a function of the originating vertex Vᵢ and time. The function r(t) represents a sphere with linearly growing radius of rate β, following a delay α from the moment of activation:

r(t)=max {β(t−α), 0}, α≧0, β>0, t≧0≦t≦tₘₐₓ

Then:

Sᵢ(Vᵢ, t)=Vᵢ+r(t), t≧0

Time t is relative to the moment of activation of the vertex Vᵢ and r(t)=0 for the duration of the delay α. Time is bound between 0 and a maximum value tₘₐₓ, when the signaling surface reaches a maximum radius rₘₐₓ. The inverse of function r is function f. Function f represents the time it would take a signaling surface to reach a particular radius r: f(r)=α+r/β and tₘₐₓ=f(rₘₐₓ). Table 1 summarizes a portion of the algorithm's input parameters:

TABLE 1
Model parameters

| Parameter | Units | Description |
|---|---|---|
| ρ | time frames | refractory period after activation |
| α | time frames | signal propagation delay after activation |
| β | pixels/time frames | linear rate of signal propagation |
| Tₘₐₓ | pixels | maximum signal surface radius |

Next the signaling model can be applied to all possible pairs of vertices whether they exist or not by computing a timing matrix T. The value of matrix element tᵢⱼ represents the time a signal takes to propagate from vertex i to vertex j. The value of tᵢⱼ is expressed by tᵢⱼ=f(∥Vᵢ−Vⱼ∥) where f takes as input the Cartesian distance between the two vertices.

Functional connections can be made between two vertices if the timing difference between their activations is within some tolerance (tol or Δγ) of the timing difference stored in matrix T. The tolerance can be configured by a user using knowledge of the network under consideration. The tolerance can take into consideration the statistical noise associated with a specific ligand-receptor interaction in a cell or hardware response time of a router in the internet. For example, assume a cell's activation is delayed (either actually or the instrument measuring the cell is delayed in processing the activation) from when the signaling volume reaches the cell, then the tolerance factor would compensate for this delay.

Functional connections are introduced to the initially empty edge matrix E as follows:

$${e}_{ij} = \{ \begin{matrix}1 & if \vert ( q - p ) - {t}_{ij} \vert < tol \\ 0 & otherwise\end{matrix} \qquad 10$$

for all combinations of starting time frame p, ending time frame q, starting vertex i, and ending vertex j where the following conditions are met from the activation state matrix A:

αᵢₚ=1, α_{jq}=1, p<q, q−p≦tₘₐₓ

Thus, for two vertices i and j, with activation times p and q, a directed edge from i to j is created if the timing offset between their activations is within some acceptable tolerance of the modeled timing stored in the matrix T.

The refractory period parameter p is not used directly in the mapping algorithm when the other parameters of Table 1 are known. When any or all of the parameters are unknown, p can be used during the optimization phase 309.

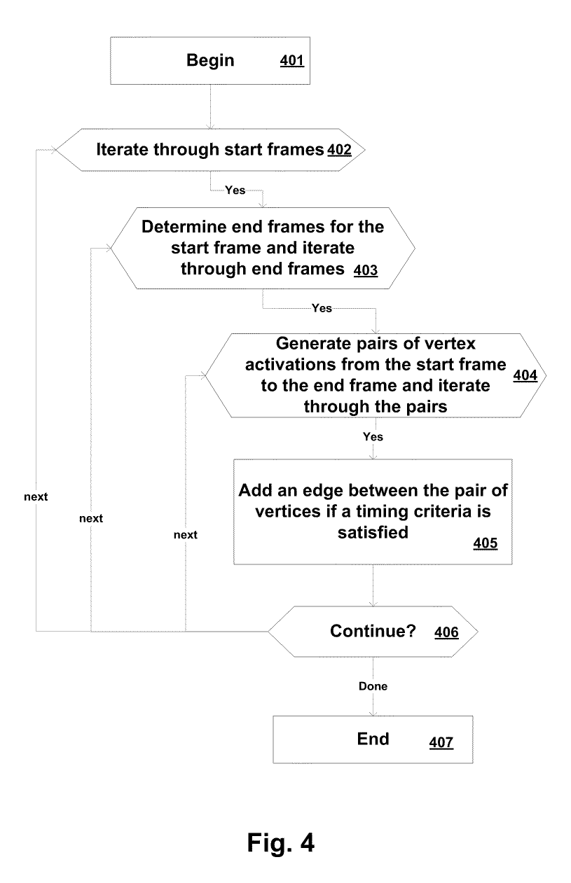

FIG. 4 depicts one example of a mapping algorithm used to generate an edge matrix. In step 401, the algorithm takes as input a activation state matrix and node locations. Other inputs can include the delay time, signaling speed, rₘₐₓ, and tolerance parameters. In step 402, the algorithm iterates through the frames that were used to make up the activation state matrix. At this step, the frames are referred to as start frames. In step 403, the end frames are determined for the current start frame. The end frames come after a current start frame. The algorithm loops through the end frames. Step 404 generates pairs of vertex activations from a current start frame to a current end frame. For each pair, step 405 will add an edge in the edge matrix between the vertices of the pair if a timing criteria is satisfied. At step 406, the algorithm will loop through the various loops until completion. When completed in step 407, the generation of the edge matrix is finished.

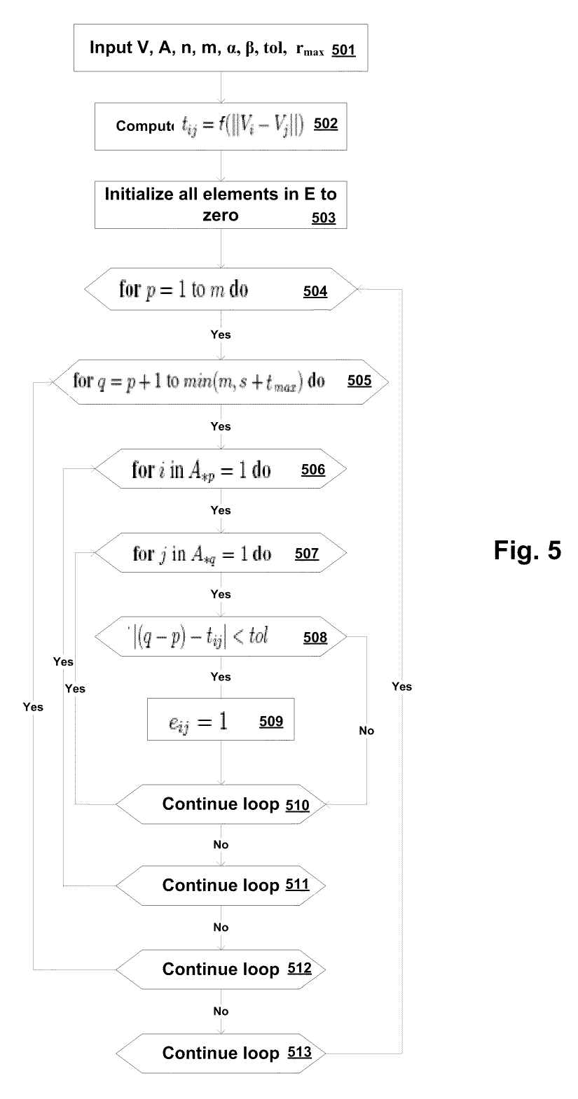

FIG. 5 illustrates a detailed flow chart of one embodiment of the network mapping algorithm. The algorithm takes as input the locations of n vertices in a vector V, an activation state matrix of size n×m where m is the number of frames and n is the number of vertices, parameters α, β, rₘₐₓ as described in table 1, and a tolerance parameter tol in step 501. Step 502 calculates the timing matrix T, where each element tᵢⱼ is computed as previously described. Step 503 initializes all elements of an edge matrix E of size n×n to zero. Step 504 loops over each frame index from 1 to m with p being the iterator. Step 505 loops from p+1 to minimum (m, s+tₘₐₓ) with q being the iterator. As previously mentioned, tₘₐₓ=f(rₘₐₓ). At the time index of p, Step 506 loops through all of elements of A_{*p} that are equal to 1 with i being the iterator. At the time index of q, Step 507 loops through all of the elements of A_{*q} that are equal to 1 with j being the iterator. At step 508, the absolute value of the difference between tᵢⱼ and the difference between q and p is computed and is expressed by |(q−p)−tᵢⱼ|. If the absolute difference is less than the tolerance value, tol, then step 509 occurs, otherwise the loop continues at step 510. If the comparison is true in step 508, eᵢⱼ is set to 1 in step 509 otherwise eᵢⱼ remains at 0. If the loop of 507 is finished, then control flows back to the loop of 506. If the loop of 506 is finished, then control flows back to the loop of 505. If the loop of 505 is finished, then control flows back to 504. If 504 is finished, then return E to the caller of the algorithm.

$${V}_{i} ( τ ) = {p}_{i} + S ( τ ) [ \begin{matrix}cos θ \cdot cos φ \\ sin θ \cdot cos φ \\ sin φ\end{matrix} ] \qquad 0 \leq θ < 2 π , - π \leq φ \leq π$$

The following describes one particular mathematical expression of an algorithm to determine a functional mapping. The position of vertex i in space (e.g. pᵢ=(xᵢ, yᵢ, zᵢ)) can be represented by pᵢ. An expanding volume, whose surface represents the region of active signaling, begins at the moment of vertex i activation ^{na}tᵢ and is defined as:
where τ=t−^{na}tᵢ. The signaling volume Vᵢ(τ) is bounded for values of t so that the signaling volume is positive and limited to a maximum radius rₘₐₓ for all vertices. rₘₐₓ is the maximum length an edge can take between any two vertices; rₘₐₓ is can be a known or measurable network specific parameter. In one implementation, rₘₐₓ can be the maximum diffusion distance of a signaling molecule between neurons. In another implementation, rₘₐₓ can be the effective distance between routers in the Internet. S(τ) is the effective radius of the expanding volume that takes into account the tolerance Δγ and is defined as

$$S ( t ) = s ∈ R ; \qquad r ( t ) - \frac{Δγ}{2} < s < r ( t ) + \frac{Δγ}{2}$$

r(t) is the positive time dependent expanding radius of the volume with r(t)≦rₘₐₓ given by

$$\begin{matrix} r ( t ) = {\int }_{r}^{r + T} f ( t ) d t \\ \frac{d r ( t )}{d t} = f ( t )\end{matrix}$$

where f(t) is the speed of the expanding signaling volume. In some network systems there can be a delay between receiving a signal and sending a signal. If a delay time D is assumed, defined as the time delay between the arrival of a signal at a vertex and the signals subsequent propagation to other vertices, r(t) becomes

$$r ( t ) = {\int }_{( r - D )}^{( r - D ) + T} f ( t ) d t$$

In other implementations of a complex network, a signal speed f(t) can vary across vertices. In such inhomogeneous networks, fᵢ(t) can be defined for each vertex i which results in a set of inhomogeneous vertex dependent signaling volumes Vᵢ(t) given by rᵢ(t). In this embodiment an edge eᵢⱼ can be mapped if

p_{j*}(^{na}tⱼ−^{na}tᵢ)εVᵢ(τ)

If a vertex pⱼ which activates at time ^{na}tⱼ is in the set of points describing the expanding shell Vᵢ(t), then the edge eᵢⱼ can be mapped.

A graph, G=(V, E), can contain a set V of n vertices and a set E of edges between those vertices. E is matrix of size n×n, where an element of E, e_{ij,}, denotes a directed edge from vertex i to vertex j if the value of the element is 1. T represents a timing matrix where an element, tᵢⱼ, represents the time that a signal would take to propagate from vertex i to vertex j based upon the signaling model regardless of a physical connection existing or not between the two vertices. A vertex activation time matrix is represented by F (size n×m) in which fᵥₜ describes the state of vertex v at time t. The value of an element of F can either be active (1) or inactive (0). However in other embodiments, other values for elements of F are possible. The imaging module 201 can be configured to produce the vertex activation time matrix. A frame denotes a particular time slice (all elements of a time index) of F. For each frame k in F, ^{na}Vₖ denotes the set of newly active vertices (changing state from 0 to 1) and can be referred to as the activation set. The sets of newly active vertices at frames s and e, ^{na}Vₛ and ^{na}Vₑ, where s ranges from 1 to m and e ranges from s+1 to m or s+viewframes. Viewframes is the timing matrix equivalent of rₘₐₓ. Frame s is the starting or reference frame of when a signal originates at a given vertex. Frame e is the ending frame that starts at s+1 and ranges to viewframes. The maximum length of an edge is bounded by viewframes. Each set ^{na}Vₑ from s to viewframes keeps track of newly activated vertices in frame e. The time deference between s and e is given by δ=e−s. s is iterated from 1 to m−1 (one frame less than the length of the movie) and for each value of s, e is iterated from s+1 to s+viewframes or until the end of the movie. ^{o}T represents an observed timing matrix with the following definition for the matrix elements:

$${}_{}^{o}{t}{}_{ij}^{} = \{ \begin{matrix}δ & for all combinations of {}_{}^{na}{V}{}_{s}^{} and {}_{}^{na}{V}{}_{e}^{} \\ 0 & otherwise\end{matrix}$$

with i being the vertex index in contained in ^{na}Vₛ and j the vertex index contained in ^{na}Vₑ. ^{o}T is the same size as T (n×n). By comparing the set of all vertices in the network activated as given by ^{o}T with the calculated timing matrix T that describes when vertices can be activated, and iterating over the entire evolving network, the functional links that connect vertices can be calculated.

The following describes one example of the mapping algorithm called NodeTrac. The mapping module 202 can be configured to run NodeTrac. The algorithm generates a network structure based on the activation times and locations of individual nodes. When a node (vertex) is activated, a signaling circle of constant growth rate emanates from the node center. The node activation times and growing signaling circles are color coded with respect to time. If a node activates at the same time as a signaling circle from a previously activated node, then the algorithm adds a connection between the nodes. In regards to FIG. 1A, for two nodes to be connected, e.g., node 110 and node 111, the node color (the node's activation time) and a signaling circle from another node must intersect and have the same color (time) in order to have a connection. The computed network connections from this algorithm are similar to those shown in FIG. 1B.

Define N as the set of nodes (vertices) in the network. Each Nᵢ is a vector containing the x and y coordinates of the node relative to the viewport origin. Where the viewport refers to the frame dimensions of the movie. Define D as the distance matrix. Dᵢⱼ is the Cartesian distance between two nodes in the network and can be alternatively expressed by distᵢⱼ. Define signal function Tᵢⱼ=deltime+sigSpeed*distᵢⱼ. Tᵢⱼ specifies the time for the signal to propagate from node i to node j. The time delay is represented by deltime and the signaling speed by sigSpeed. Define Fₙₜ as the matrix containing the individual node activation states where n is the node id and t is the frame number. An element of F can take on the following values 1 (ACTIVE), 0 (INACTIVE), and −1 (INHIBITED). In other embodiments of the algorithm more or less values can be permitted. Define E as the connectivity matrix. A directed link from node i to node j is indicated by Eᵢⱼ equaling 1.

The following is a pseudo-code description of the network mapping algorithm, NodeTrac, implemented in the mapNet method.

```
  function mapNet(Matrix F, Vector N, sigspeed, delTime)
    determine the viewport size (can also be passed in as a parameter)
        sizex = max(Nx)
        sizey = max(Ny)
    setup the estimated network with given node positions and viewport
    generate the D distance matrix for all nodes
    define a timing matrix: Tij = delTime + Dij / sigSpeed
    define the maximum view frame window viewfrs
        viewfrs = delTime + sqrt(sizex−2 + sizey\hat{ }2)*sigSpeed
    for(f from 0 to #frames)
        fromnodes = newly activated nodes at frame f
        foreach(node in fromnodes)
            for(nf from f to f+viewframes) -lookahead for future
active nodes
                tonodes = newly activated nodes at frame nf
                foreach(fnode in fromnodes AND tnode in tonodes)
                    if (nf − f = Ttnode , f node) then
                      add link between tnode and fnode in
network
                    endif
                end foreach
            end for
        end foreach
    end for
```

The first step in the mapping algorithm is the generation of a timing matrix T, that holds the times a signal would take to go from one node to another. T is defined as Tᵢⱼ=delTime+Dᵢⱼ/sigSpeed where delTime is the time between a node receiving a signal and the node passing a signal to the connected cell(s), and sigSpeed is the signal speed. delTime can be in time units and sigSpeed can be in units of distance units over time unites.

The next step involves looping twice through the frames matrix, first to determine source nodes and second to determine target nodes. The primary loop parses the entire matrix, while the secondary loop only looks ahead viewframes, which is the maximum time that a signal would take to diagonally traverse the viewport: viewframes=delTime+sqrt(sizex²+sizey²)/sigSpeed.

The newly activated nodes of any frame are the nodes which became active in that frame. Nodes may stay active for more than one frame, but only the activation time is taken into account. From the primary frame loop a list of newly active nodes is generated, fromnodes, while tonodes is the list of newly active nodes for each frame in the secondary loop. A link exists for each node in fromnodes to each node in tonodes if the time delta between the primary and secondary loop counters is within tolerance of the T matrix for that from/to node combination. In other words, if signaling time between node a and b as observed in the movie matches a distance based signaling model, then a link between a and b can exist.

Mapped subgraphs can be added together to provide a more accurate mapped network. One approach to determining real networks connectivity, for example, is adding together subgraphs generated from movies with different starting nodes (points). Better results can be obtained using multiple short movies of the same node, activated at different locations. The resulting mapped networks from these movies can be added together to form a larger network graph that is more accurate and more complete.

In one embodiment of the mapping algorithm, the delay time and signaling parameters can be solved for by using linear algebra and the signaling model of Tᵢⱼ: Tᵢⱼ=delTime+Dᵢⱼ/sigSpeed.

For a given node i, a set of two or more additional nodes that have different distances and signaling times from i can form a set of equations that can be used to solve for delTime and sigspeed.

It is useful for a user of the mapping algorithm to simulate the network as previously described in the simulation module 203. The simulation module can be configured to measure accuracy. Accuracy can be defined as follows:

$$Accuracy = \frac{correctly mapped edges - incorrectly mapped edges}{total mapped edges}$$

In one embodiment of the optimization step 309, simulated annealing can be used to determine the parameters used in the network mapping step 308. Simulated annealing involves the dynamic simulation of the mapped network to obtain a simulated activation state matrix, the comparison of the simulated to the observed activation state matrix, and the optimization of the parameters to minimize the difference between the observed and modeled activation state matrices.

An allowable range can be established for each parameter being optimized of the signaling model; initial values can be chosen at random within that range. With the initial values, a network edge matrix can be obtained using a mapping algorithm. Using the same activation and signaling model used for mapping and with a refractory period, a simulated activation state matrix A′ can be constructed starting with the same initial state as in the observed activation state matrix A. If one vertex is initially active in A at the first frame, then that vertex will be active in A′ and be the seed vertex for A′. All vertices connected to the seed vertex will be activated at later times based on the signaling speeds, delay times, and distance from seed vertex, thus propagating a signal through the network, using only the edges mapped in E. A′ will be of the same dimensions as the observed state matrix A, and the initial state of A′ will be the same as A, implying that the first columns of A′ will be set equal to A.

By comparing the observed and simulated state matrices A and A′, we can obtain a fitness metric of the mapping and of the parameters used in the mapping. Because simulated annealing is the optimization algorithm for this embodiment, the fitness metric is the energy function and a perfect match can be obtained when A′=A which means that the energy function will be zero. Because both A′ and A can be sparse matrices with values of 0 or 1, one approach is to smooth out the active frames a_{if}=1 over multiple frames using a Gaussian filter g, thus making the definition of an energy function U more suitable for minimization:

$$U = {\sum }_{i = 1}^{n} {\sum }_{f = 1}^{m} \vert ( {a}_{if}^{′} - {a}_{if} ) ⋆ g \vert$$

Taking the difference of the signals between observed and simulated activation states for a particular vertex, convolving the outcome with a smoothing Gaussian, then taking the absolute value and summing the resultant vector across all frames of that vertex produces a non-negative metric of closeness between the two signals. If the observed and simulated activation states for that vector match, the vertex energy is zero and the vertex energy increases with increasing distance between the activation times. The total energy U is the sum of the all the individual vertex energies, and ranges from zero when a perfect match is achieved up to Uₘₐₓ where no edges were mapped and thus A′ is also empty. Since the area under a Gaussian filter is 1, and A′=0:

$${U}_{max} = {\sum }_{i = 1}^{n} {\sum }_{f = 1}^{m} {a}_{if}$$

By having an energy measure of the mapping algorithm that compares the observed activation states with the simulated activation states from the mapped network, the optimization step anneals the parameters to a value which minimizes the energy and thus optimizes the mapping. Through this step, the network connectivity map and the signaling model parameters, among other parameters, can be obtained.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., a code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of what is disclosed here, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

A computer system for implementing the disclosed embodiments can include client computers (clients) and server computers (servers). A client and a server are generally remote from each other and typically interact through a communication network. The relationship of client and server can arise by virtue of computer programs running on the respective computers and having a client-server relationship to each other.

While this specification contains many specifics, these should not be construed as limitations on the scope of any invention or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed:

1. A method for analyzing a networked system, comprising:
monitoring activation and deactivation of nodes in a networked system to obtain information on activation times and deactivation times of nodes and locations of nodes; and
using activation times and deactivation times of nodes to generate a connection link between first and second nodes at two different node locations when the first node is activated at the same time as a signaling from the second node reaches the location of the first node, thus producing a connection map of nodes in the networked system.

2. The method as in claim 1, wherein the networked system is a circuit network.

3. The method as in claim 1, wherein the networked system is a computer network.

4. The method as in claim 1, wherein the networked system is a biological network.

5. The method as in claim 1, wherein the networked system includes content objects in a computer database.

6. A computer program product, encoded on a computer-readable medium, operable to cause data processing apparatus to perform operations comprising:
monitoring activation and deactivation of nodes in the networked system to obtain information on activation times and deactivation times of nodes and locations of nodes; and
using activation times and deactivation times of nodes to generate a connection link between first and second nodes at two different node locations when the first node is activated at the same time as a signaling from the second node reaches the location of the first node, thus producing a connection map of nodes in the networked system.

7. A method for analyzing a networked system, comprising:
monitoring activation and deactivation of nodes in a networked system to obtain information on activation times and deactivation times of nodes and locations of nodes;
applying a signaling model to generate a timing matrix of the nodes in the networked system to hold signaling times for a signal to travel from one node to a different node; and
comparing signaling times in the timing matrix and monitored activation times of the nodes to generate a map of connection links between different nodes.

8. The method as in claim 7, wherein the networked system is a circuit network.

9. The method as in claim 7, wherein the networked system is a computer network.

10. The method as in claim 7, wherein the networked system is a biological network.

11. The method as in claim 7, wherein the networked system includes content objects in a computer database.

12. A computer program product, encoded on a computer-readable medium, operable to cause data processing apparatus to perform operations comprising:
monitoring activation and deactivation of nodes in a networked system to obtain information on activation times and deactivation times of nodes and locations of nodes;
applying a signaling model to generate a timing matrix of the nodes in the networked system to hold signaling times for a signal to travel from one node to a different node; and
comparing signaling times in the timing matrix and monitored activation times of the nodes to generate a map of connection links between different nodes.

13. A method for constructing a functional structure map of a networked system, comprising:
capturing activation states of a set of network vertices over a period of time;
comparing a first vertex that is activated in a current time to one or more second vertices that are newly activated at a later time; and
adding a connection between the first vertex and the one or more second vertices if a signaling volume expanding from first vertex can reach the one or more second vertices within a tolerance.

14. The method of claim 13, wherein the set of network vertices comprises biological neurons.

15. The method of claim 13, wherein the set of network vertices comprises computer routers.

16. The method of claim 13, wherein the signaling volume expands at a different rate for at least a portion of vertices in the set of network vertices.

17. The method of claim 13, wherein the signaling volume depends on a set of parameters.

18. The method of claim 17, comprising applying simulated annealing to optimize the set of parameters.

19. A system for analyzing a networked system, comprising:
an imaging module to process a set of sequential images of a networked system to determine locations of nodes and activation times of the nodes in the networked system; and
a mapping module in communication with the imaging module to generate network connections based on the determined locations of the nodes and the determined activation times of the nodes in the networked system.

20. The system as in claim 19, comprising:
a simulation module in communication with the mapping module to use the generated network connections to simulate the networked system to produce a set of sequential images of the simulated networked system and to compare the set of sequential images of the simulated networked system to the set of sequential images of the networked system.

21. The system as in claim 19, wherein the image module and mapping module reside in a single computer.

22. The system as in claim 19, wherein the image module and mapping module reside in two or more networked computers.

23. A system for analyzing a networked system, comprising:
Means for monitoring activation and deactivation of nodes in a networked system to obtain information on activation times and deactivation times of nodes and locations of nodes; and
Means for using activation times and deactivation times of nodes to generate a connection link between first and second nodes at two different node locations when the first node is activated at the same time as a signaling from the second node reaches the location of the first node, thus producing a connection map of nodes in the networked system.

24. A system for analyzing a networked system, comprising:
means for monitoring activation and deactivation of nodes in a networked system to obtain information on activation times and deactivation times of nodes and locations of nodes;
means for applying a signaling model to generate a timing matrix of the nodes in the networked system to hold signaling times for a signal to travel from one node to a different node; and
means for comparing signaling times in the timing matrix and monitored activation times of the nodes to generate a map of connection links between different nodes.

25. A system for constructing a functional structure map of a networked system, comprising:
means for capturing activation states of a set of network vertices over a period of time;
means for comparing a first vertex that is activated in a current time to one or more second vertices that are newly activated at a later time; and
means for adding a connection between the first vertex and the one or more second vertices if a signaling volume expanding from first vertex can reach the one or more second vertices within a tolerance.

26. A system for analyzing a networked system, comprising:
means for processing a set of sequential images of a networked system to determine locations of nodes and activation times of the nodes in the networked system; and
means for generating network connections based on the determined locations of the nodes and the determined activation times of the nodes in the networked system.
